(19) United States
(12) Patent Application Publication
(10) Pub. No.: US 2026/0124872 A1
(43) Pub. Date: May 7, 2026

(54) THERMAL MANAGEMENT SYSTEM FOR A VEHICLE

(71) Applicants: HYUNDAI MOTOR COMPANY, Seoul (KR); KIA CORPORATION, Seoul (KR)

(72) Inventors: Chan Woong Jo, Hwaseong-si (KR); Minseob Shin, Hwaseong-si (KR); Yong Woong Cha, Hwaseong-si (KR); Seong-Bin Jeong, Hwaseong-si (KR)

(73) Assignees: HYUNDAI MOTOR COMPANY, Seoul (KR); KIA CORPORATION, Seoul (KR)

(21) Appl. No.: 19/232,337

(22) Filed: Jun. 9, 2025

(30) Foreign Application Priority Data
Nov. 4, 2024 (KR) 10-2024-0154353

(51) Int. Cl. B60H 1/00; B60K 11/02; B60L 50/60

(52) U.S. Cl. CPC B60H 1/00571; B60H 1/00278; B60H 1/00392; B60K 11/02; B60L 50/60

(57) ABSTRACT

A thermal management system for a vehicle enables removing a radiator and streamlining the components of the thermal management system. The thermal management system efficiently adjusts the temperature of the battery module and the electrical component, excluding the motor, by using a single chiller where a refrigerant and a coolant exchange heat.

### CROSS-REFERENCE TO RELATED APPLICATION

This application claims priority to and the benefit of Korean Patent Application No. 10-2024-0154353, filed with the Korean Intellectual Property Office on Nov. 4, 2024, the entire contents of which is incorporated herein by reference.

### BACKGROUND

### Technical Field

The present disclosure relates to a thermal management system for a vehicle, and more particularly, the present disclosure relates to a thermal management system for a vehicle capable of efficiently adjusting the temperature of the battery module and the electrical component excluding the motor.

### Description of the Related Art

In recent years, an electric vehicle has become popular as a future transporting means, as the environment and energy resources are becoming important issues. The electric vehicle uses a battery module in which a plurality of rechargeable cells are formed as one pack as a main power source, and thus no exhaust gas is generated and noise is very low.

Such an electric vehicle is driven by a motor which operates through electric power supplied from the battery module. In addition, the electric vehicle includes electrical components for controlling and managing the motor as well as a plurality of electronic convenience devices and charging the battery module.

Since a large amount of heat is generated in the battery module and the motor used as a primary power source of the electric vehicle, as well as the electrical components, efficient cooling is required, so efficient temperature management of the electrical components and the battery module may be a very important problem.

In addition, since a battery module performs optimally at a preset temperature, it needs to be rapidly heated up to the preset temperature in the early stage of driving.

Separate cooling systems are applied to adjust the temperature of the electrical components and the battery module, but it is necessary to increase capacity of the cooling system according thereto, which leads to space restrictions. Further, when the capacity of the cooling systems is increased, power required for operating the cooling systems is also increased.

The above information disclosed in this Background section is only for enhancement of understanding of the background of the disclosure, and therefore it may contain information that does not form the prior art that is already known to a person having ordinary skill in the art.

### SUMMARY

The present disclosure provides a thermal management system for a vehicle capable of removing a radiator, and streamlining the entire components, by efficiently adjusting the temperature of the battery module and the electrical component excluding the motor by using a single chiller where a refrigerant and a coolant are heat-exchanged.

According to an embodiment of the present disclosure, a thermal management system for a vehicle may include: a motor configured to provide a driving torque to the vehicle; a battery module configured to provide an electrical power to the motor; and an air conditioner unit including a condenser and a chiller and configured to circulate a refrigerant. The thermal management system further includes a cooling apparatus including a coolant line connected to the chiller to cool the battery module and an electrical component, which is provided in the vehicle, by using a coolant heat-exchanged with the refrigerant at the chiller. The coolant line may include a first connection line on which the battery module is provided, and a second connection line on which the electrical component, excluding the motor, is provided. In particular, the first connection line and the second connection line may be configured in parallel.

The motor may be connected to a motor cooling apparatus configured to cool the motor by using an oil. The motor cooling apparatus may include an oil cooler connected to the motor through an oil line, and a hydraulic pump provided on the oil line, and the motor cooling apparatus is configured to circulate the oil cooled at the oil cooler along the oil line.

In an embodiment, a valve may be provided at a location where the first connection line and the second connection line branched from the coolant line rejoin the coolant line so that the coolant having passed through the chiller passes through the battery module and the electrical component respectively through the first connection line and the second connection line and then flows back into the chiller.

A valve may be provided at a position where the first connection line and the second connection line, which are branched from the coolant line, rejoin the coolant line so that the coolant having passed through the chiller flows respectively through the battery module and the electrical component via the first connection line and the second connection line, and is then introduced back into the chiller.

A water pump may be provided on the coolant line at an upstream end of the chiller.

An inner diameter of the first connection line and an inner diameter of the second connection line may be different from each other.

The inner diameter of the first connection line may be greater than the inner diameter of the second connection line.

A battery heater may be further provided on the first connection line so that the coolant passes through the battery module and the battery heater.

Based on a flow direction of the coolant, a first water pump may be provided on the first connection line at an upstream end of the battery module, and a second water pump may be provided on the second connection line at an upstream end of the electrical component, based on the flow direction of the coolant.

The first water pump and the second water pump may be operated at different rotation speeds (e.g., revolution per minute (RPM)) so that flow rates of respective coolants flowing through the first connection line and the second connection line are different.

A pumping head of the first water pump may be greater than a pumping head of the second water pump so that flow rates of respective coolants flowing through the first connection line and the second connection line are different.

A battery heater may be further provided on the first connection line, and the coolant flowing along the first connection line passes through the battery heater and the battery module.

A reservoir tank may be provided at a location where the first connection line and the second connection line, branched from the coolant line, rejoin the coolant line, or a position where the first connection line and the second connection line are branched from the coolant line, based on a coolant flow direction.

In an embodiment of the present disclosure, a thermal management system for a vehicle may include: a motor configured to provide a driving torque to the vehicle; a battery module configured to provide an electrical power to the motor; an air conditioner unit including a condenser and a chiller, and configured to circulate a refrigerant; and a cooling apparatus including a coolant line connected to the chiller to cool the battery module and an electrical component provided in the vehicle by using a coolant heat-exchanged with the refrigerant at the chiller. The battery module is disposed in series with the chiller on the coolant line. In particular, the electrical component includes: a first end connected to the coolant line at an upstream end of the chiller, and a second end provided on a branch line connected to the coolant line at a downstream end of the battery module. The battery module and the electrical component is disposed in parallel through the coolant line and the branch line.

The motor may be connected to a motor cooling apparatus configured to cool the motor by using an oil. The motor cooling apparatus may include an oil cooler connected to the motor through an oil line, and a hydraulic pump provided on the oil line. The motor cooling apparatus is configured to circulate the oil cooled at the oil cooler along the oil line.

A partial coolant among the coolant introduced into the chiller along the coolant line may flow through the branch line to detour the chiller and pass through the electrical component. The remaining coolant, among the coolant introduced into the chiller along the coolant line, may sequentially pass through the chiller and the battery module and then rejoins with the partial coolant flowing along the branch line at the coolant line.

An inner diameter of the coolant line and an inner diameter of the branch line may be different from each other.

The inner diameter of the coolant line may be greater than the inner diameter of the branch line.

A water pump may be provided on the coolant line at the downstream end of the battery module, and a second end of the branch line may be connected to the coolant line between the battery module and the water pump.

A reservoir tank may be provided on the coolant line at an upstream end of the water pump.

A battery heater may be further provided on the coolant line so that the coolant passes through the battery module and the battery heater.

As described above, according to a thermal management system for a vehicle according to an embodiment of the present disclosure, by efficiently adjusting the temperature of the battery module and the electrical component excluding the motor by using a single chiller where a refrigerant and a coolant exchange heat, a radiator may be removed, and the entire components may be streamlined.

In addition, according to the present disclosure, by reducing the operation time of the battery heater through an efficient temperature control so that the optimal performance of the battery module and the electrical component may be obtained, the overall power consumption may be minimized.

In addition, according to the present disclosure, by efficiently adjusting the temperature of the battery module, the optimal performance of the battery module may be achieved, and the overall travel distance of the vehicle may be increased through efficient management of the battery module.

In addition, according to the present disclosure, through streamlining of the entire system, simplification of the system layout, reduction of manufacturing cost, and reduction of weight may be achieved, and space utilization may be improved.

### BRIEF DESCRIPTION OF THE DRAWINGS

FIG. 1 is a block diagram of a thermal management system for a vehicle according to a first embodiment of the present disclosure.

FIG. 2 is a block diagram of a thermal management system for a vehicle according to a second embodiment of the present disclosure.

FIG. 3 is a block diagram of a thermal management system for a vehicle according to a third embodiment of the present disclosure.

FIG. 4 is a block diagram of a thermal management system for a vehicle according to a fourth embodiment of the present disclosure.

### DETAILED DESCRIPTION

Embodiments of the present disclosure are hereinafter described in detail with reference to the accompanying drawings.

Embodiments of the present disclosure and the constructions depicted in the drawings are by way of example and are not intended to limit the scope of the present disclosure, which is defined by the appended claims and encompasses all modifications, equivalents, and alternatives falling within their scope.

In order to clarify the present disclosure, parts that are not related to the description may have been omitted. Further, the same elements or equivalents are referred to with the same reference numerals throughout the specification.

The size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include”, and variations thereof such as “comprises” or “comprising”, should be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

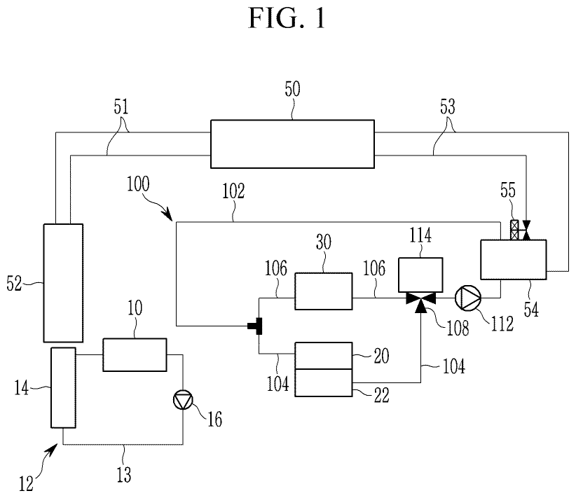

FIG. 1 is a block diagram of a thermal management system for a vehicle according to a first embodiment of the present disclosure.

In a thermal management system for a vehicle according to a first embodiment of the present disclosure, by efficiently adjusting temperatures of a battery module 20 and an electrical component 30, excluding a motor 10, by using a single chiller 54 where a refrigerant and a coolant exchange heat, a radiator may be removed, and the entire components may be streamlined. In other words, the thermal management system efficiently adjusts the temperatures of the battery module 20 and electrical component 30 (excluding motor 10) using the single chiller 54 for refrigerant-coolant heat exchange, enabling radiator removal and system simplification.

Referring to FIG. 1, the thermal management system may include the motor 10, the battery module 20, an air conditioner unit 50, and a cooling apparatus 100.

The motor 10 may provide a driving torque to the vehicle. The battery module 20 may provide an electrical power to the motor 10 and supply power to the electrical component 30.

The electrical component 30 may include at least one of an electrical power control apparatus, an inverter, or an on-board charger (OBC). The electrical power control apparatus or the inverter may generate heat during driving of the vehicle, and the charger may generate heat when charging the battery module 20.

The motor 10 may be connected to a motor cooling apparatus 12 configured to cool the motor 10 by using an oil.

In an embodiment of the present disclosure, the motor cooling apparatus 12 may include an oil cooler 14 and a hydraulic pump 16.

The oil cooler 14 may be connected to the motor 10 through an oil line 13.

In addition, the hydraulic pump 16 may be provided on the oil line 13. The hydraulic pump 16 may circulate the oil cooled at the oil cooler 14 along the oil line 13.

The oil cooler 14 may be disposed at a front of the vehicle. The oil cooler 14 may cool the introduced oil through exchanging heat with an ambient air. In other words, the oil cooler 14 may be an air-cooled heat-exchanger.

The motor cooling apparatus 12 configured as such may smoothly cool the motor 10 by circulating the oil cooled at the oil cooler 14 through the oil line 13 according to the operation of the hydraulic pump 16.

In the first embodiment of the present disclosure, the air conditioner unit 50 may circulate the refrigerant through an operation of respective components in a selected air conditioning mode for a temperature control of a vehicle interior.

The air conditioner unit 50 may include a condenser 52 and the chiller 54. In addition, although not shown in the drawings, the air conditioner unit 50 may further include a compressor, an evaporator, and a first expansion valve.

The condenser 52 may be connected to the air conditioner unit 50 through a refrigerant line 51. In other words, the compressor, the evaporator, and the first expansion valve may be connected to the condenser 52 through the refrigerant line 51.

The condenser 52 may be disposed at the front of the vehicle together with the oil cooler 14. In other words, the condenser 52 may be an air-cooled heat-exchanger configured to exchange heat between the introduced refrigerant and the ambient air.

In addition, the chiller 54 may be connected to the air conditioner unit 50 through a refrigerant connection line 53. Based on a flow direction of the refrigerant, a second expansion valve 55 may be provided on the refrigerant connection line 53, at an upstream end of the chiller 54.

In addition, the cooling apparatus 100 may include a coolant line 102 connected to the chiller 54, to cool the battery module 20 and the electrical component 30 by using the coolant heat-exchanged with the refrigerant at the chiller 54.

The coolant line 102 may include a first connection line 104 on which the battery module 20 is provided, and a second connection line 106 on which the electrical component 30 is provided.

The first connection line 104 and the second connection line 106 may be branched from the coolant line 102, respectively, and may be configured in parallel with each other.

Accordingly, the battery module 20 and the electrical component 30 may be disposed in parallel through the first connection line 104 and the second connection line 106.

In the first embodiment of the present disclosure, a battery heater 22 may be further provided on the first connection line 104. The battery heater 22 may be provided on the first connection line 104 separately from the battery module 20, or integrally formed with the battery module 20.

The battery heater 22 may selectively heat the coolant introduced through the first connection line 104, to increase a temperature of the coolant.

Accordingly, the first connection line 104 may be connected to the battery module 20 and the battery heater 22 so that the coolant may sequentially pass through the battery module 20 and the battery heater 22.

In other words, the coolant introduced into the first connection line 104 may sequentially pass through the battery module 20 and the battery heater 22.

When the battery module 20 and the electrical component 30 are to be cooled by using the coolant heat-exchanged with the refrigerant, the second expansion valve 55 may expand the refrigerant introduced through the refrigerant connection line 53 and flow the expanded refrigerant to the chiller 54.

The chiller 54 may adjust the temperature of the coolant selectively supplied through the coolant line 102 by exchanging heat between the refrigerant supplied from the air conditioner unit 50 and the coolant.

In other words, the chiller 54 may be a water-cooled heat-exchanger configured to exchange heat between an interiorly introduced refrigerant and the coolant.

The coolant heat-exchanged with the refrigerant at the chiller 54 may be supplied to the battery module 20 and the electrical component 30 through the first and second connection lines 104 and 106, respectively, to adjust the temperatures of the battery module 20 and the electrical component 30.

In addition, when heating the vehicle interior, the chiller 54 may recollect the waste heat of the battery module 20 and the electrical component 30 while exchanging heat between the refrigerant and the interiorly introduced coolant.

Accordingly, in the cooling apparatus 100, by adjusting the temperature of the coolant circulating through the coolant line 102 by using the chiller 54 through which the refrigerant flows, and supplying the coolant to the battery module 20 and the electrical component 30, a radiator conventionally employed for cooling of the coolant may be removed.

In a first embodiment of the present disclosure, a valve 108 may be provided at a location where the first connection line 104 and the second connection line 106 branched from the coolant line 102 rejoin the coolant line 102 so that the coolant having passed through the chiller 54 passes through the battery module 20 and the electrical component 30 respectively through the first connection line 104 and the second connection line 106, and then flows back into the chiller 54.

The coolant line 102 connected to the chiller 54, the first connection line 104, and the second connection line 106 may be respectively connected to the valve 108.

The valve 108 may adjust the flow rate of the coolant supplied to the battery module 20 and the electrical component 30 through the first connection line 104 and the second connection line 106, respectively, to correspond to the battery module 20 and the electrical component 30 having different target temperatures.

For example, a target temperature of the battery module 20 may be set to be lower than a target temperature of the electrical component 30.

In this case, the valve 108 may adjust the flow rate of the coolant respectively flowing to the first connection line 104 and the second connection line 106 so that the coolant supplied to the battery module 20 through the first connection line 104 is a higher flow rate than the flow rate of the coolant supplied to the electrical component 30 through the second connection line 106.

In other words, the valve 108 may be a 3-way valve that can control the flow direction and flow rate of the coolant.

In addition, a water pump 112 may be provided on the coolant line 102 at the upstream end of the chiller 54 so that the coolant is circulated along the coolant line 102.

When cooling or heating of the battery module 20 and the electrical component 30 is required, the water pump 112 may operate so that the coolant having passed through the chiller 54 along the coolant line 102 may be introduced into the battery module 20 and the electrical component 30 through the first and second connection lines 104 and 106, respectively.

The upstream end of the chiller 54 and a downstream end of the chiller 54 may be set based on a flow direction of the coolant.

In other words, based on the direction in which the coolant flows along the coolant line 102, a location where the coolant is introduced into the chiller 54 may be defined as an upstream end of the chiller 54, and a location where the coolant is discharged from the chiller 54 may be defined as a downstream end of the chiller 54.

In addition, the cooling apparatus 100 may further include a reservoir tank 114.

The reservoir tank 114 may be disposed at a location where the first connection line 104 and the second connection line 106, branched from the coolant line 102, rejoin the coolant line 102 based on the coolant flow direction.

In a first embodiment of the present disclosure, the reservoir tank 114 may be connected to the valve 108. The reservoir tank 114 may replenish the coolant so that the flow rate of the coolant circulating through the cooling apparatus 100 may not become insufficient.

In a first embodiment of the present disclosure, an inner diameter of the first connection line 104 and an inner diameter of the second connection line 106 may be different inner diameters.

In other words, in the cooling apparatus 100, the first connection line 104 and the second connection line 106 may be different inner diameters so that flow rate of the supplied coolant is adjusted to correspond to the battery module 20 and the electrical component 30 having different target temperatures.

In more detail, the inner diameter of the first connection line 104 may be a greater inner diameter than the inner diameter of the second connection line 106 so that a relatively large flow rate of the coolant is supplied to the battery module 20 to correspond to the target temperature of the battery module 20 that is relatively lower compared to the target temperature of the electrical component 30.

The valve 108 may not be applied to the cooling apparatus 100.

In other words, when the inner diameter of the first connection line 104 is greater than the inner diameter of the second connection line 106, the flow rate of the coolant flowing through the first connection line 104 may be relatively higher than the flow rate of the coolant flowing through the second connection line 106 without an operation of the valve 108.

The cooling apparatus 100 may control the flow rate of the coolant through adjustment of inner diameters of the first connection line 104 and the second connection line 106 without employing the valve 108.

Therefore, the thermal management system may efficiently perform the flow rate distribution of the coolant flowing through the first connection line 104 and the second connection line 106 through an operation control of the valve 108, or adjustment of inner diameters of the first connection line 104 and the second connection line 106.

The thermal management system may secure the maximum flow rate of the coolant supplied to the battery module 20 and the electrical component 30 along the first connection line 104 and the second connection line 106, respectively, to be appropriate for respective target temperatures of the battery module 20 and the electrical component 30.

Accordingly, the cooling performance of the battery module 20 and the electrical component 30 may be improved.

Therefore, in the thermal management system according to a first embodiment of the present disclosure configured as described above, by employing the motor cooling apparatus 12 for a temperature control of the motor 10, and also the cooling apparatus 100 configured to cool the battery module 20 and the electrical component 30 by using the coolant having its temperature adjusted at the chiller 54, a radiator for cooling the coolant may be removed.

The thermal management system may efficiently adjust the temperatures of the battery module 20 and the electrical component 30, by adjusting the flow rate of the coolant to be appropriate for the target temperature of the battery module 20 and the target temperature of the electrical component 30.

The thermal management system according to a first embodiment of the present disclosure takes an example of, the cooling apparatus 100, one of applying the valve 108 for adjusting the flow rate of the coolant, or forming inner diameters of the first connection line 104 and the second connection line 106 to be different from each other, but it is not limited thereto, and the valve 108 may be applied while forming inner diameters of the first and second connection lines 104 and 106 to be different.

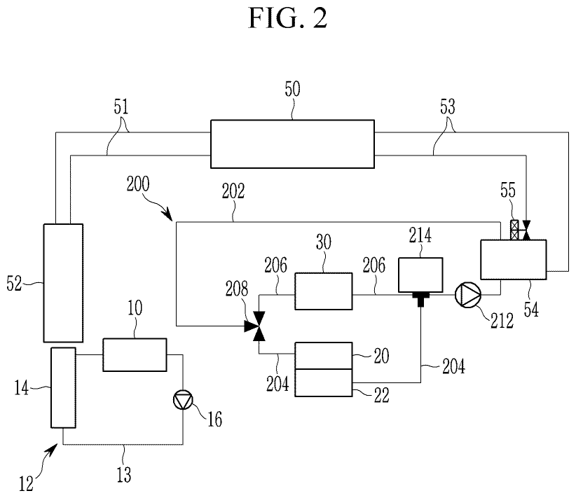

A thermal management system for a vehicle according to a second embodiment of the present disclosure is described with reference to FIG. 2.

FIG. 2 is a block diagram of a thermal management system for a vehicle according to a second embodiment of the present disclosure.

In a thermal management system for a vehicle according to a second embodiment of the present disclosure, by efficiently adjusting the temperatures of the battery module 20 and the electrical component 30 excluding the motor 10 by using the single chiller 54 where the refrigerant and the coolant exchange heat, a radiator may be removed, and the entire components may be streamlined.

Referring to FIG. 2, the thermal management system according to a second embodiment of the present disclosure may include the motor 10, the battery module 20, the air conditioner unit 50, and a cooling apparatus 200.

The motor 10 may provide a driving torque to the vehicle. The battery module 20 may provide an electrical power to the motor 10, and at the same time, supply power to the electrical component 30.

The electrical component 30 may include an electrical power control apparatus, an inverter, or an on-board charger (OBC). The electrical power control apparatus or the inverter may generate heat during driving of the vehicle, and the charger may generate heat when charging the battery module 20.

The motor 10 may be connected to the motor cooling apparatus 12 configured to cool the motor 10 by using an oil.

In a second embodiment of the present disclosure, the motor cooling apparatus 12 may include the oil cooler 14 and the hydraulic pump 16.

The oil cooler 14 may be connected to the motor 10 through the oil line 13.

In addition, the hydraulic pump 16 may be provided on the oil line 13. The hydraulic pump 16 may circulate the oil cooled at the oil cooler 14 along the oil line 13.

The oil cooler 14 may be disposed at the front of the vehicle. The oil cooler 14 may cool the introduced oil through heat-exchange with the ambient air. In other words, the oil cooler 14 may be an air-cooled heat-exchanger.

The motor cooling apparatus 12 configured as such may smoothly cool the motor 10 by circulating the oil cooled at the oil cooler 14 through the oil line 13 through the operation of the hydraulic pump 16.

In a second embodiment of the present disclosure, the air conditioner unit 50 may circulate the refrigerant through the operation of respective components in a selected air conditioning mode for the temperature control of the vehicle interior.

The air conditioner unit 50 may include the condenser 52 and the chiller 54. In addition, although not shown in the drawings, the air conditioner unit 50 may further include a compressor, an evaporator, and a first expansion valve.

The condenser 52 may be connected to the air conditioner unit 50 through the refrigerant line 51. In other words, the compressor, the evaporator, and the first expansion valve may be connected to the condenser 52 through the refrigerant line 51.

The condenser 52 may be disposed at the front of the vehicle together with the oil cooler 14. In other words, the condenser 52 may be an air-cooled heat-exchanger configured to exchange heat between the introduced refrigerant and the ambient air.

In addition, the chiller 54 may be connected to the air conditioner unit 50 through the refrigerant connection line 53. Based on the flow direction of the refrigerant, the second expansion valve 55 may be provided on the refrigerant connection line 53, at the upstream end of the chiller 54.

In addition, the cooling apparatus 200 may include a coolant line 202 connected to the chiller 54, to cool the battery module 20 and the electrical component 30 by using the coolant heat-exchanged with the refrigerant at the chiller 54.

The coolant line 202 may include a first connection line 204 on which the battery module 20 is provided, and a second connection line 206 on which the electrical component 30 is provided.

The first connection line 204 and the second connection line 206 may be branched from the coolant line 202, respectively, and may be configured in parallel with each other.

Accordingly, the battery module 20 and the electrical component 30 may be disposed in parallel through the first connection line 204 and the second connection line 206.

In a second embodiment of the present disclosure, the battery heater 22 may be further provided on the first connection line 204. The battery heater 22 may be provided on the first connection line 204 separately from the battery module 20, or integrally formed with the battery module 20.

The battery heater 22 may selectively heat the coolant introduced through the first connection line 204, to increase the temperature of the coolant.

Accordingly, the first connection line 204 may be connected to the battery module 20 and the battery heater 22 so that the coolant may sequentially pass through the battery module 20 and the battery heater 22.

In other words, the coolant introduced into the first connection line 204 may sequentially pass through the battery module 20 and the battery heater 22.

When the battery module 20 and the electrical component 30 are to be cooled by using the coolant heat-exchanged with the refrigerant, the second expansion valve 55 may expand the refrigerant introduced through the refrigerant connection line 53 and flow the expanded refrigerant to the chiller 54.

The chiller 54 may adjust the temperature of the coolant selectively supplied through the coolant line 202 by heat-exchanging the refrigerant supplied from the air conditioner unit 50 with the coolant.

In other words, the chiller 54 may be a water-cooled heat-exchanger configured to exchange heat between the interiorly introduced refrigerant with the coolant.

The coolant heat-exchanged with the refrigerant at the chiller 54 may be supplied to the battery module 20 and the electrical component 30 through the first and second connection lines 204 and 206, respectively, to adjust the temperatures of the battery module 20 and the electrical component 30.

In addition, when heating the vehicle interior, the chiller 54 may recollect the waste heat of the battery module 20 and the electrical component 30 while exchanging heat between the refrigerant and the interiorly introduced coolant.

Accordingly, in the cooling apparatus 200, by adjusting the temperature of the coolant circulating through the coolant line 202 by using the chiller 54 through which the refrigerant flows, and supplying the coolant to the battery module 20 and the electrical component 30, a radiator conventionally employed for cooling of the coolant may be removed.

In a second embodiment of the present disclosure, a valve 208 is provided at a position where the first connection line 204 and the second connection line 206 are branched from the coolant line 202 so that the coolant having passed through the chiller 54 is introduced into the battery module 20 and the electrical component 30 respectively through the first connection line 204 and the second connection line 206.

The coolant line 202 connected to the chiller 54, the first connection line 204, and the second connection line 206 may be respectively connected to the valve 208.

The valve 208 may adjust the flow rate of the coolant supplied to the battery module 20 and the electrical component 30 through the first connection line 204 and the second connection line 206, respectively, to correspond to the battery module 20 and the electrical component 30 having different target temperatures.

For example, the target temperature of the battery module 20 may be set to be lower than the target temperature of the electrical component 30.

The valve 208 may adjust the flow rate of the coolant respectively flowing to the first connection line 204 and the second connection line 206 so that the coolant supplied to the battery module 20 through the first connection line 204 has a higher flow rate than the flow rate of the coolant supplied to the electrical component 30 through the second connection line 206.

In other words, the valve 208 may be a 3-way valve that can control the flow direction and flow rate of the coolant.

In addition, a water pump 212 may be provided on the coolant line 202 at the upstream end of the chiller 54 so that the coolant is circulated along the coolant line 202.

When cooling or heating of the battery module 20 and the electrical component 30 is required, the water pump 212 may operate so that the coolant having passed through the chiller 54 along the coolant line 202 may be introduced into the battery module 20 and the electrical component 30 through the first and second connection lines 204 and 206, respectively.

The upstream end of the chiller 54 and the downstream end of the chiller 54 may be set based on the flow direction of the coolant.

In other words, based on the direction in which the coolant flows along the coolant line 202, a location where the coolant is introduced into the chiller 54 may be defined as an upstream end of the chiller 54, and a location where the coolant is discharged from the chiller 54 may be defined as a downstream end of the chiller 54.

In addition, the cooling apparatus 200 may further include a reservoir tank 214.

The reservoir tank 214 may be disposed at a location where the first connection line 204 and the second connection line 206, branched from the coolant line 202, rejoin the coolant line 202 based on the coolant flow direction.

In other words, in a second embodiment of the present disclosure, the reservoir tank 214 may replenish the coolant so that the flow rate of the coolant circulating through the cooling apparatus 200 may not become insufficient.

In a second embodiment of the present disclosure, an inner diameter of the first connection line 204 and an inner diameter of the second connection line 206 may be different inner diameters.

In other words, in the cooling apparatus 200, the first connection line 204 and the second connection line 206 may be different inner diameters so that the flow rate of the supplied coolant is adjusted to correspond to the battery module 20 and the electrical component 30 having different target temperatures.

The inner diameter of the first connection line 204 may be a greater inner diameter than the inner diameter of the second connection line 206 so that a relatively large flow rate of the coolant is supplied to the battery module 20 to correspond to the target temperature of the battery module 20 that is relatively lower compared to the target temperature of the electrical component 30.

The valve 208 may not be applied to the cooling apparatus 200.

In other words, when the inner diameter of the first connection line 204 is formed to be greater than the inner diameter of the second connection line 206, the flow rate of the coolant flowing through the first connection line 204 may be relatively higher than the flow rate of the coolant flowing through the second connection line 206 without an operation of the valve 208.

The cooling apparatus 200 may control the flow rate of the coolant through adjustment of inner diameters of the first connection line 204 and the second connection line 206 without employing the valve 208.

The thermal management system may efficiently perform the flow rate distribution of the coolant flowing through the first connection line 204 and the second connection line 206 through an operation control of the valve 208, or adjustment of inner diameters of the first connection line 204 and the second connection line 206.

In addition, the thermal management system may secure the maximum flow rate of the coolant supplied to the battery module 20 and the electrical component 30 along the first connection line 204 and the second connection line 206, respectively, to be appropriate for respective target temperatures of the battery module 20 and the electrical component 30.

Accordingly, the cooling performance of the battery module 20 and the electrical component 30 may be improved.

Therefore, in the thermal management system according to a second embodiment of the present disclosure configured as described above, by employing the motor cooling apparatus 12 for the temperature control of the motor 10, and also the cooling apparatus 200 configured to cool the battery module 20 and the electrical component 30 by using the coolant cooled at the chiller 54, a radiator for cooling the coolant may be removed.

In addition, the thermal management system may efficiently adjust the temperatures of the battery module 20 and the electrical component 30, by adjusting the flow rate of the coolant to be appropriate for the target temperature of the battery module 20 and the target temperature of the electrical component 30.

The thermal management system according to a second embodiment of the present disclosure takes an example of, the cooling apparatus 200, one of applying the valve 208 for adjusting the flow rate of the coolant, or forming inner diameters of the first connection line 204 and the second connection line 206 to be different from each other, but it is not limited thereto, and the valve 208 may be applied while forming inner diameters of the first and second connection lines 204 and 206 to be different.

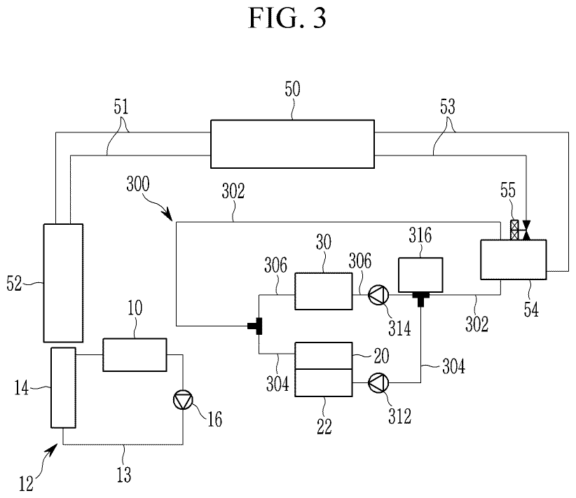

A thermal management system for a vehicle according to a third embodiment of the present disclosure is described in detail with reference to FIG. 3.

FIG. 3 is a block diagram of a thermal management system for a vehicle according to a third embodiment of the present disclosure.

In a thermal management system for a vehicle according to a third embodiment of the present disclosure, by efficiently adjusting the temperatures of the battery module 20 and the electrical component 30 excluding the motor 10 by using the single chiller 54 where the refrigerant and the coolant exchange heat, a radiator may be removed, and the entire components may be streamlined.

Referring to FIG. 3, the thermal management system according to a third embodiment of the present disclosure may include the motor 10, the battery module 20, the air conditioner unit 50, and a cooling apparatus 300.

The motor 10 may provide a driving torque to the vehicle. The battery module 20 may provide an electrical power to the motor 10, and supply power to the electrical component 30.

The electrical component 30 may include an electrical power control apparatus, an inverter, or an on-board charger (OBC). The electrical power control apparatus or the inverter may generate heat during driving of the vehicle, and the charger may generate heat when charging the battery module 20.

The motor 10 may be connected to the motor cooling apparatus 12 configured to cool the motor 10 by using an oil.

In a third embodiment of the present disclosure, the motor cooling apparatus 12 may include the oil cooler 14 and the hydraulic pump 16.

The oil cooler 14 may be connected to the motor 10 through the oil line 13.

In addition, the hydraulic pump 16 may be provided on the oil line 13. The hydraulic pump 16 may circulate the oil cooled at the oil cooler 14 along the oil line 13.

The oil cooler 14 may be disposed at the front of the vehicle. The oil cooler 14 may cool the introduced oil through exchanging heat with the ambient air. In other words, the oil cooler 14 may be an air-cooled heat-exchanger.

The motor cooling apparatus 12 configured as such may smoothly cool the motor 10 by circulating the oil cooled at the oil cooler 14 through the oil line 13 through the operation of the hydraulic pump 16.

In a third embodiment of the present disclosure, the air conditioner unit 50 may circulate the refrigerant through the operation of respective components in a selected air conditioning mode for the temperature control of the vehicle interior.

The air conditioner unit 50 may include the condenser 52 and the chiller 54. In addition, although not shown in the drawings, the air conditioner unit 50 may further include a compressor, an evaporator, and a first expansion valve.

The condenser 52 may be connected to the air conditioner unit 50 through the refrigerant line 51. In other words, the compressor, the evaporator, and the first expansion valve may be connected to the condenser 52 through the refrigerant line 51.

The condenser 52 may be disposed at the front of the vehicle together with the oil cooler 14. In other words, the condenser 52 may be an air-cooled heat-exchanger configured to exchange heat between the introduced refrigerant and the ambient air.

In addition, the chiller 54 may be connected to the air conditioner unit 50 through the refrigerant connection line 53. Based on the flow direction of the refrigerant, the second expansion valve 55 may be provided on the refrigerant connection line 53, at the upstream end of the chiller 54.

In addition, the cooling apparatus 300 may include a coolant line 302 connected to the chiller 54, to cool the battery module 20 and the electrical component 30 by using the coolant heat-exchanged with the refrigerant at the chiller 54.

The coolant line 302 may include a first connection line 304 on which the battery module 20 is provided, and a second connection line 306 on which the electrical component 30 is provided.

The first connection line 304 and the second connection line 306 may be branched from the coolant line 302, respectively, and may be configured in parallel with each other.

Accordingly, the battery module 20 and the electrical component 30 may be disposed in parallel through the first connection line 304 and the second connection line 306.

In a third embodiment of the present disclosure, the battery heater 22 may be further provided on the first connection line 304. The battery heater 22 may be provided on the first connection line 304 separately from the battery module 20, or integrally formed with the battery module 20.

The battery heater 22 may selectively heat the coolant introduced through the first connection line 304, to increase the temperature of the coolant.

Accordingly, the first connection line 304 may be connected to the battery module 20 and the battery heater 22 so that the coolant may sequentially pass through the battery module 20 and the battery heater 22.

In other words, the coolant introduced into the first connection line 304 may sequentially pass through the battery heater 22 and the battery module 20.

When the battery module 20 and the electrical component 30 are to be cooled by using the coolant heat-exchanged with the refrigerant, the second expansion valve 55 may expand the refrigerant introduced through the refrigerant connection line 53 and flow the expanded refrigerant to the chiller 54.

The chiller 54 may adjust the temperature of the coolant selectively supplied through the coolant line 302 by exchanging heat between the refrigerant supplied from the air conditioner unit 50 and the coolant.

In other words, the chiller 54 may be a water-cooled heat-exchanger configured to exchange heat between the interiorly introduced refrigerant and the coolant.

The coolant heat-exchanged with the refrigerant at the chiller 54 may be supplied to the battery module 20 and the electrical component 30 through the first and second connection line 304, and 306, respectively, to adjust the temperatures of the battery module 20 and the electrical component 30.

In addition, when heating the vehicle interior, the chiller 54 may recollect the waste heat of the battery module 20 and the electrical component 30 while exchanging heat between the refrigerant and the interiorly introduced coolant.

Accordingly, in the cooling apparatus 300, by adjusting the temperature of the coolant circulating through the coolant line 302 by using the chiller 54 through which the refrigerant flows, and supplying the coolant to the battery module 20 and the electrical component 30, a radiator conventionally employed for cooling of the coolant may be removed.

In a third embodiment of the present disclosure, a first water pump 312 may be provided on the first connection line 304, and a second water pump 314 may be provided on the second connection line 306.

The first water pump 312 may be provided on the first connection line 304 at an upstream end of the battery module 20, based on the flow direction of the coolant.

In addition, the second water pump 314 may be provided on the second connection line 306 at an upstream end of the electrical component 30, based on the flow direction of the coolant.

The first water pump 312 and the second water pump 314 may be operated in different rotation speeds (e.g., revolution per minute (RPM)) so that flow rates of respective coolants flowing through the first connection line 304 and the second connection line 306 become different.

In other words, when the first water pump 312 and the second water pump 314 are configured as pumps having the same pumping heads, the first water pump 312 and the second water pump 314 may be operated in different RPMs (i.e., revolution per minute) so that the flow rates of the coolant supplied to the battery module 20 and the electrical component 30 through the first connection line 304 and the second connection line 306 may be different from each other.

The pumping head refers to a height a pump can lift when pumping liquid.

In a third embodiment of the present disclosure, the RPM (i.e., revolution per minute) of the first water pump 312 may operate in a greater RPM (i.e., revolution per minute) than the RPM (i.e., revolution per minute) of the second water pump 314, to correspond to the target temperature of the battery module 20 that is relatively lower compared to the target temperature of the electrical component 30.

Accordingly, when the first water pump 312 operates at an RPM greater than the RPM of the second water pump 314, the flow rate of the coolant supplied to the battery module 20 through the first connection line 304 may be relatively larger than the flow rate of the coolant supplied to the electrical component 30 through the second connection line 306.

Therefore, the thermal management system may efficiently perform the flow rate distribution of the coolant flowing through the first connection line 304 and the second connection line 306, by operating the first water pump 312 and the second water pump 314 at a different RPM.

In addition, the thermal management system may secure the maximum flow rate of the coolant supplied to the battery module 20 and the electrical component 30 along the first connection line 312 and the second connection line 314, respectively, to be appropriate for respective target temperatures of the battery module 20 and the electrical component 30.

Accordingly, the cooling performance of the battery module 20 and the electrical component 30 may be improved.

In a third embodiment of the present disclosure, when the first water pump 312 and the second water pump 314 are configured as pumps having different pumping heads, a pumping head of the first water pump 312 may have a greater pumping head than the pumping head of the second water pump 314 so that flow rates of respective coolants flowing through the first connection line 304 and the second connection line 306 become different.

Accordingly, when the first water pump 312 has a pumping head greater than that of the second water pump 314, the flow rate of the coolant supplied to the battery module 20 through the first connection line 304 may be greater than the flow rate of the coolant supplied to the electrical component 30 through the second connection line 306.

In other words, the pumping head of the first water pump 312 may be configured in a greater pumping head than the pumping head of the second water pump 314 so that a relatively large flow rate of the coolant is supplied to the battery module 20 to correspond to the target temperature of the battery module 20 that is relatively lower compared to the target temperature of the electrical component 30.

Therefore, by employing the first water pump 312 and the second water pump 314 having different pumping heads, the thermal management system may efficiently perform the flow rate distribution of the coolant flowing through the first connection line 304 and the second connection line 306.

In addition, the thermal management system may secure the maximum flow rate of the coolant supplied to the battery module 20 and the electrical component 30 along the first connection line 304 and the second connection line 306, respectively, to be appropriate for respective target temperatures of the battery module 20 and the electrical component 30.

Accordingly, the cooling performance of the battery module 20 and the electrical component 30 may be improved.

The upstream end of the battery module 20 and a downstream end of the battery module 20, or the upstream end of the electrical component 30 and a downstream end of the electrical component 30 may be set based on the flow direction of the coolant.

In other words, based on the direction in which the coolant flows along the coolant line 302, a location where the coolant is introduced into the battery module 20 may be defined as an upstream end of the battery module 20, and a location where the coolant is discharged from the battery module 20 may be defined as a downstream end of the battery module 20.

In addition, based on the direction in which the coolant flows along the coolant line 302, a location where the coolant is introduced into the electrical component 30 may be defined as an upstream end of the electrical component 30, and a location where the coolant is discharged from the electrical component 30 may be defined as a downstream end of the electrical component 30.

In addition, the cooling apparatus 300 may further include a reservoir tank 316.

The reservoir tank 316 may be disposed at a position where the first connection line 304 and the second connection line 306 are branched from the coolant line 302 based on the coolant flow direction.

The reservoir tank 316 may replenish the coolant so that the flow rate of the coolant circulating through the cooling apparatus 300 may not become insufficient.

Therefore, in the thermal management system according to a third embodiment of the present disclosure configured as described above, by employing the motor cooling apparatus 12 for the temperature control of the motor 10, and also the cooling apparatus 300 configured to cool the battery module 20 and the electrical component 30 by using the coolant cooled at the chiller 54, a radiator for cooling the coolant may be removed.

In addition, by adjusting the flow rate of the coolant to be appropriate for the target temperature of the battery module 20 and the target temperature of the electrical component 30 by operating the first water pump 312 and the second water pump 314, the thermal management system can efficiently adjust the temperatures of the battery module 20 and the electrical component 30.

In the thermal management system according to a third embodiment of the present disclosure, the cases where the first water pump 312 and the second water pump 314 are applied as pumps having the same pumping heads or as pumps having different pumping heads were separated in the description, but is not limited thereto, and in the case that pumps having different pumping heads are applied, the rotation speeds of the first water pump 312 and the second water pump 314 may be controlled to be different.

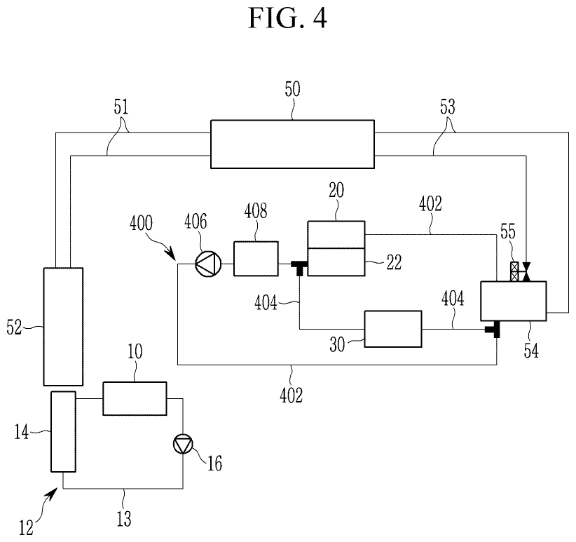

In addition, a thermal management system for a vehicle according to a fourth embodiment of the present disclosure is described with reference to FIG. 4.

FIG. 4 is a block diagram of a thermal management system for a vehicle according to a fourth embodiment of the present disclosure.

In a thermal management system for a vehicle according to a fourth embodiment of the present disclosure, by efficiently adjusting the temperatures of the battery module 20 and the electrical component 30 excluding the motor 10 by using the single chiller 54 where the refrigerant and the coolant exchange heat, a radiator may be removed, and the entire components may be streamlined.

Referring to FIG. 4, the thermal management system may include the motor 10, the battery module 20, the air conditioner unit 50, and a cooling apparatus 400.

The motor 10 may provide a driving torque to the vehicle. The battery module 20 may provide an electrical power to the motor 10, and supply power to the electrical component 30.

The electrical component 30 may include an electrical power control apparatus, an inverter, or an on-board charger (OBC). The electrical power control apparatus or the inverter may generate heat during driving of the vehicle, and the charger may generate heat when charging the battery module 20.

The motor 10 may be connected to the motor cooling apparatus 12 configured to cool the motor 10 by using an oil.

In a fourth embodiment of the present disclosure, the motor cooling apparatus 12 may include the oil cooler 14 and the hydraulic pump 16.

The oil cooler 14 may be connected to the motor 10 through the oil line 13.

In addition, the hydraulic pump 16 may be provided on the oil line 13. The hydraulic pump 16 may circulate the oil cooled at the oil cooler 14 along the oil line 13.

The oil cooler 14 may be disposed at the front of the vehicle. The oil cooler 14 may cool the introduced oil through heat-exchange with the ambient air. In other words, the oil cooler 14 may be an air-cooled heat-exchanger.

The motor cooling apparatus 12 configured as such may smoothly cool the motor 10 by circulating the oil cooled at the oil cooler 14 through the oil line 13 through the operation of the hydraulic pump 16.

In a fourth embodiment of the present disclosure, the air conditioner unit 50 may circulate the refrigerant through the operation of respective components in a selected air conditioning mode for the temperature control of the vehicle interior.

The air conditioner unit 50 may include the condenser 52 and the chiller 54. In addition, although not shown in the drawings, the air conditioner unit 50 may further include a compressor, an evaporator, and a first expansion valve.

The condenser 52 may be connected to the air conditioner unit 50 through the refrigerant line 51. In other words, the compressor, the evaporator, and the first expansion valve may be connected to the condenser 52 through the refrigerant line 51.

The condenser 52 may be disposed at the front of the vehicle together with the oil cooler 14. In other words, the condenser 52 may be an air-cooled heat-exchanger configured to exchange heat between the introduced refrigerant and the ambient air.

In addition, the chiller 54 may be connected to the air conditioner unit 50 through the refrigerant connection line 53. Based on the flow direction of the refrigerant, the second expansion valve 55 may be provided on the refrigerant connection line 53, at the upstream end of the chiller 54.

In addition, the cooling apparatus 400 may include a coolant line 402 connected to the chiller 54, to cool the battery module 20 and the electrical component 30 by using the coolant heat-exchanged with the refrigerant at the chiller 54. The cooling apparatus 400 may further include a branch line 404.

A first end of the branch line 404 may be connected to the coolant line 402 at the upstream end of the chiller 54. A second end of the branch line 404 may be connected to the coolant line 402 at the downstream end of the battery module 20.

The battery module 20 may be disposed in series with the chiller 54 on the coolant line 402.

In addition, the electrical component 30 may be provided on the branch line 404.

Accordingly, the battery module 20 and the electrical component 30 may be disposed in parallel through the coolant line 402 and the branch line 404.

In other words, a partial coolant among the coolant introduced into the chiller 54 along the coolant line 402 may flow through the branch line 404 to detour the chiller 54 and pass through the electrical component 30.

In addition, a remaining coolant among the coolant introduced into the chiller 54 along the coolant line 402 may sequentially pass through the chiller 54 and the battery module 20 and then rejoin with a partial coolant flowing along the branch line 404 at the coolant line 402.

In a fourth embodiment of the present disclosure, the battery heater 22 may be further provided on the coolant line 402. The battery heater 22 may be provided on the coolant line 402 separately from the battery module 20, or integrally formed with the battery module 20.

The battery heater 22 may selectively heat the coolant introduced through the coolant line 402, to increase the temperature of the coolant.

Accordingly, the coolant line 402 may be connected to the battery module 20 and the battery heater 22 so that the coolant may sequentially pass through the battery module 20 and the battery heater 22.

In other words, the coolant flowing along the coolant line 402 may sequentially pass through the battery module 20 and the battery heater 22.

When the battery module 20 and the electrical component 30 are to be cooled by using the coolant heat-exchanged with the refrigerant, the second expansion valve 55 may expand the refrigerant introduced through the refrigerant connection line 53 and flow the expanded refrigerant to the chiller 54.

The chiller 54 may adjust the temperature of the coolant selectively supplied through the coolant line 402 by exchanging heat between the refrigerant supplied from the air conditioner unit 50 and the coolant.

In other words, the chiller 54 may be a water-cooled heat-exchanger configured to exchange heat between the interiorly introduced refrigerant and the coolant.

The coolant heat-exchanged with the refrigerant at the chiller 54 may be supplied to the battery module 20 and the electrical component 30 through the coolant line 402 and the branch line 404, respectively, to adjust the temperatures of the battery module 20 and the electrical component 30.

In addition, when heating the vehicle interior, the chiller 54 may recollect the waste heat of the battery module 20 and the electrical component 30 while exchanging heat between the refrigerant with the interiorly introduced coolant.

Accordingly, in the cooling apparatus 400, by adjusting the temperature of the coolant circulating through the coolant line 402 and the branch line 404 by using the chiller 54 through which the refrigerant flows, and supplying the coolant to the battery module 20 and the electrical component 30, a radiator conventionally employed for cooling of the coolant may be removed.

A water pump 406 may be provided on the coolant line 402 at the downstream end of the battery module 20 so that the coolant is circulated along the coolant line 402 and the branch line 404.

The second end of the branch line 404 may be connected to the coolant line 402 between the battery module 20 and the water pump 406.

When cooling or heating of the battery module 20 and the electrical component 30 is required, the water pump 406 may operate so that the coolant having passed through the chiller 54 passes through the battery module 20 through the coolant line 402, and then is introduced into the electrical component 30 through the branch line 404.

The upstream end of the battery module 20 and the downstream end of the battery module 20, or the upstream end of the chiller 54 and the downstream end of the chiller 54, or an upstream end of the water pump 406 and a downstream end of the water pump 406 may be set based on the flow direction of the coolant.

In other words, based on the direction in which the coolant flows along the coolant line 402, a location where the coolant is introduced into the battery module 20, the chiller 54, and the water pump 406 may be defined as an upstream end, and the battery module 20, the chiller 54, and a location where the coolant is discharged from the water pump 406 may be defined as a downstream end.

In addition, the cooling apparatus 400 may further include a reservoir tank 408. The reservoir tank 408 may be disposed on the coolant line 402 at the upstream end of the water pump 406 based on the coolant flow direction.

The reservoir tank 408 may be provided on the coolant line 402 between a position where the second end of the branch line 404 is connected to the coolant line 402 and the upstream end of the water pump 406.

The reservoir tank 408 may replenish the coolant so that the flow rate of the coolant circulating through the cooling apparatus 400 may not become insufficient.

In a fourth embodiment of the present disclosure, an inner diameter of the coolant line 402 and an inner diameter of the branch line 404 may be different inner diameters.

In other words, in the cooling apparatus 400, the coolant line 402 and the branch line 404 may be different inner diameters so that the flow rate of the supplied coolant is adjusted to correspond to the battery module 20 and the electrical component 30 having different target temperatures.

The inner diameter of the coolant line 402 may be a greater inner diameter than the inner diameter of the branch line 404 so that a relatively large flow rate of the coolant is supplied to the battery module 20 to correspond to the target temperature of the battery module 20 that is relatively lower compared to the target temperature of the electrical component 30.

In other words, when the inner diameter of the coolant line 402 is formed to be greater than the inner diameter of the branch line 404, the flow rate of the coolant flowing through the coolant line 402 may be relatively larger than the flow rate of the coolant flowing through the branch line 404.

The cooling apparatus 400 may control the flow rate of the coolant through adjustment of inner diameters of the coolant line 402 and the branch line 404 without employing a separate valve.

Therefore, the thermal management system may efficiently perform the flow rate distribution of the coolant flowing through the coolant line 402 and the branch line 404 through adjustment of inner diameters of the coolant line 402 and the branch line 404.

In addition, the thermal management system may secure the maximum flow rate of the coolant supplied to the battery module 20 and the electrical component 30 along the coolant line 402 and the branch line 404, respectively, to be appropriate for respective target temperatures of the battery module 20 and the electrical component 30.

Accordingly, the cooling performance of the battery module 20 and the electrical component 30 may be improved.

Therefore, in the thermal management system according to a fourth embodiment of the present disclosure configured as described above, by employing the motor cooling apparatus 12 for the temperature control of the motor 10, and also the cooling apparatus 400 configured to cool the battery module 20 and the electrical component 30 by using the coolant having its temperature adjusted at the chiller 54, a radiator for cooling the coolant may be removed.

In addition, the thermal management system may efficiently adjust the temperatures of the battery module 20 and the electrical component 30, by adjusting the flow rate of the coolant to be appropriate for the target temperature of the battery module 20 and the target temperature of the electrical component 30.

Therefore, as described above, when a thermal management system for a vehicle according to embodiments of the present disclosure is employed, by efficiently adjusting the temperatures of the battery module 20 and the electrical component 30 excluding the motor 10 by using a single chiller 54 where the refrigerant and the coolant are heat-exchanged, a radiator may be removed, and the entire components may be streamlined.

In addition, according to the present disclosure, by reducing the operation time of the battery heater 22 through an efficient temperature control so that the optimal performance of the battery module 20 and the electrical component 30 may be obtained, the overall power consumption may be minimized.

In addition, according to the present disclosure, by efficiently adjusting the temperature of the battery module 20, the optimal performance of the battery module 20 may be achieved, and the overall travel distance of the vehicle may be increased through efficient management of the battery module 20.

In addition, according to the present disclosure, through streamlining of the entire system, simplification of the system layout, reduction of manufacturing cost, and reduction of weight may be achieved, and space utilization may be improved.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: motor
12: motor cooling apparatus
13: oil line
14: oil cooler
16: hydraulic pump
20: battery module
22: battery heater
30: electrical component
50: air conditioner unit
51: refrigerant line
52: condenser
53: refrigerant connection line
54: chiller
55: second expansion valve
100, 200, 300, 400: cooling apparatus
102, 202, 302, 402: coolant line
104, 204, 304: first connection line
106, 206, 306: second connection line
108, 208: valve
112, 212, 406: water pump
114, 214, 316, 408: reservoir tank
312, 314: first and second water pumps
404: branch line

What is claimed is:

1. A thermal management system for a vehicle, the thermal management system comprising:
a motor configured to provide a driving torque to the vehicle;
a battery module configured to provide an electrical power to the motor;
an air conditioner unit including a condenser and a chiller, the air conditioner unit configured to circulate a refrigerant; and
a cooling apparatus including a coolant line connected to the chiller to cool the battery module and an electrical component provided in the vehicle by using a coolant heat-exchanged with the refrigerant at the chiller,
wherein the coolant line includes:
a first connection line on which the battery module is provided, and
a second connection line on which the electrical component, excluding the motor, is provided, and
wherein the first connection line and the second connection line are configured in parallel.

2. The thermal management system of claim 1, further comprising a motor cooling apparatus configured to cool the motor by using an oil,
wherein the motor cooling apparatus includes:
an oil cooler connected to the motor through an oil line; and
a hydraulic pump provided on the oil line, the hydraulic pump configured to circulate the oil cooled at the oil cooler along the oil line.

3. The thermal management system of claim 1, wherein a valve is provided at a location where the first connection line and the second connection line, branched from the coolant line, rejoin the coolant line such that the coolant having passed through the chiller passes through the battery module via the first connection line and electrical component via the second connection line, and flows back into the chiller along the coolant line.

4. The thermal management system of claim 1, wherein a valve is provided at a position where the first connection line and the second connection line are branched from the coolant line such that the coolant having passed through the chiller is introduced into the battery module through the first connection line and the electrical component through the second connection line.

5. The thermal management system of claim 1, wherein a water pump is provided on the coolant line at an upstream end of the chiller.

6. The thermal management system of claim 1, wherein an inner diameter of the first connection line and an inner diameter of the second connection line are different from each other.

7. The thermal management system of claim 6, wherein the inner diameter of the first connection line is greater than the inner diameter of the second connection line.

8. The thermal management system of claim 1, wherein a battery heater is further provided on the first connection line such that the coolant passes through the battery module and the battery heater.

9. The thermal management system of claim 1, wherein:
a first water pump is provided on the first connection line at an upstream end of the battery module, based on a flow direction of the coolant; and
a second water pump is provided on the second connection line at an upstream end of the electrical component, based on the flow direction of the coolant.

10. The thermal management system of claim 9, wherein the first water pump and the second water pump are operated at different rotation speeds such that a flow rate of the coolant flowing through the first connection line and a flow rate of the coolant flowing through the second connection line are different.

11. The thermal management system of claim 9, wherein a pumping head of the first water pump is greater than a pumping head of the second water pump such that a flow rate of the coolant flowing through the first connection line and a flow rate of the coolant flowing through the second connection line are different.

12. The thermal management system of claim 9, wherein a battery heater is further provided on the first connection line, and the coolant flowing along the first connection line passes through the battery heater and the battery module.

13. The thermal management system of claim 1, wherein a reservoir tank is provided at a location where the first connection line and the second connection line, branched from the coolant line, rejoin the coolant line, or a position where the first connection line and the second connection line are branched from the coolant line, based on a coolant flow direction.

14. A thermal management system for a vehicle, the thermal management system comprising:
a motor configured to provide a driving torque to the vehicle;
a battery module configured to provide an electrical power to the motor;
an air conditioner unit including a condenser and a chiller, the air conditioner unit configured to circulate a refrigerant; and
a cooling apparatus including a coolant line connected to the chiller to cool the battery module and an electrical component provided in the vehicle by using a coolant heat-exchanged with the refrigerant at the chiller,
wherein the battery module is disposed in series with the chiller on the coolant line,
wherein the electrical component includes:
a first end connected to the coolant line at an upstream end of the chiller, and
a second end provided on a branch line connected to the coolant line at a downstream end of the battery module, and
wherein the battery module and the electrical component are disposed in parallel through the coolant line and the branch line.

15. The thermal management system of claim 14,
wherein the motor is connected to a motor cooling apparatus configured to cool the motor by using an oil, and
the motor cooling apparatus includes:
an oil cooler connected to the motor through an oil line; and
a hydraulic pump provided on the oil line, the hydraulic pump configured to circulate the oil cooled at the oil cooler along the oil line.

16. The thermal management system of claim 14, wherein:
a partial coolant, among the coolant introduced into the chiller along the coolant line, flows through the branch line to detour the chiller and pass through the electrical component; and
a remaining coolant, among the coolant introduced into the chiller along the coolant line, sequentially passes through the chiller and the battery module and rejoins with the partial coolant flowing along the branch line at the coolant line.

17. The thermal management system of claim 14, wherein an inner diameter of the coolant line and an inner diameter of the branch line are different from each other.

18. The thermal management system of claim 17, wherein the inner diameter of the coolant line is greater than the inner diameter of the branch line.

19. The thermal management system of claim 14, wherein:
a water pump is provided on the coolant line at the downstream end of the battery module; and
a second end of the branch line is connected to the coolant line between the battery module and the water pump.

20. The thermal management system of claim 19, wherein a reservoir tank is provided on the coolant line at an upstream end of the water pump, and
wherein a battery heater is further provided on the coolant line such that the coolant passes through the battery module and the battery heater.
